(19) United States
(12) Patent Application Publication
(10) Pub. No.: US 2008/0008627 A1
(43) Pub. Date: Jan. 10, 2008

(54) FILLING A MICROCHANNEL IN A COMPONENT OF A FLUIDIC MICROSYSTEM

(75) Inventor: Jacques Goulpeau, Paris (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Bertin Technologies

(21) Appl. No.: 11/778,925

(22) Filed: Jul. 17, 2007

Related U.S. Application Data
(63) Continuation of application No. PCT/FR2006/000010, filed on Jan. 4, 2006.

(30) Foreign Application Priority Data
Jan. 18, 2005 (FR) 0500511

(51) Int. Cl. B32B 27/04; B32B 27/12

(52) U.S. Cl. 422/102

(57) ABSTRACT

A method of filling a microchannel formed in a component of a fluidic microsystem, the component being made of a plastics material or an elastomer suitable for absorbing gas, the method consisting in degassing the component and then in inserting a liquid into a feeder well of the microchannel, which liquid fills the microchannel because of the suction produced by the material absorbing the gas contained in the microchannel.

### CROSS REFERENCE TO RELATED APPLICATIONS

This application is a Continuation Application of International Application No. PCT/FR2006/000010, filed Jan. 4, 2006, which claims priority from French patent Application No. 0500511 filed Jan. 18, 2005.

### FIELD AND BACKGROUND OF THE INVENTION

The present invention relates to filling a microchannel in a component of a fluidic microsystem, and also to such a component adapted to such filling.

Fluidic microsystem components are usually made of a plastics material or of elastomer and they include microchannels of width and height that are a few tens to a few hundreds of micrometers. It is difficult to fill such microchannels with liquid, particularly since some of the materials in the most widespread use for making such components are hydrophobic, in particular polydimethylsiloxane (PDMS).

It is also necessary to ensure that the liquid inserted into a microchannel in such a component does not contain bubbles of air or gas since they might impede or even prevent the liquid from flowing in the microchannel. Furthermore, the plastics material or the elastomer from which the component is made absorbs gas easily and is thus liable to degas and release bubbles of gas into the liquid contained in the microchannel, e.g. as a result of a rise in temperature or of a drop in the pressure inside the microchannel.

### OBJECT AND SUMMARY OF THE INVENTION

A particular object of the present invention is to provide a solution to those problems that is simple, effective, and inexpensive.

The invention provides a method of filling a microchannel in a component of a fluidic microsystem, the component being made at least in part out of a plastics material or out of an elastomer suitable for absorbing the gases with which it is in contact, the method consisting in subjecting the component to degassing under a vacuum, then placing the component in a surrounding or ambient atmosphere, in inserting a liquid in the microchannel of the component, and in filling the microchannel with the liquid by allowing the suction that results from the component absorbing the gas contained in the microchannel to act on the liquid.

The component made of a plastics material or of elastomer and that has been degassed tends immediately to reabsorb the gas with which it comes into contact.

The invention takes advantage of this phenomenon for creating suction in a microchannel of the component, and it is this suction that is used for filling the microchannel with liquid.

The suction caused by gas being reabsorbed by the degassed component is more than enough for filling a microchannel of the usual dimensions with liquid.

If the liquid inserted into the microchannel itself contains bubbles of air or gas, these will be absorbed by the component so that the liquid filling the channel is purged of such bubbles of air or gas.

A microchannel in a component of the above-specified type can thus be filled automatically and in a manner that is particularly reliable, without it being necessary to use the means that are known for this purpose in the prior art, which means are generally not easy to implement and do not solve the problems caused by the presence of bubbles of air or gas in the liquid.

According to another characteristic of the invention, the method also consists in enclosing the degassed component under a vacuum in a hermetic package and, subsequently, in opening the package to use the component, said use comprising inserting liquid into the microchannel of the component, the time interval between opening the package containing the component and introducing the liquid into the microchannel of the component being shorter than a predetermined value.

This predetermined duration is 15 minutes (min) to 20 min approximately when the component is made of an elastomer of the PDMS type.

The component is degassed under a partial vacuum for a predetermined minimum duration, which is 1 hour (h) to 2 h approximately when the degassing is performed at a pressure of about 100 mbars to 200 mbars (10⁴ pascal (Pa) to 2×10⁴ Pa).

Preferably, in order to fill the microchannel of the component, liquid is inserted into a feeder well formed at one end of the microchannel, such that the liquid inserted into the well forms an obstacle that isolates the microchannel from the surrounding atmosphere.

The component absorbing the gas contained in the microchannel then enables the microchannel to be filled completely with the liquid without any bubbles of air or gas.

The invention also provides a fluidic microsystem component made at least in part out of a plastics material or elastomer suitable for absorbing gas, and including at least one microchannel that is to be filled with a liquid, the component being previously degassed under a vacuum and wherein it is packaged under a vacuum in a hermetic package.

In a preferred embodiment of the invention, the component includes a feeder well open at one end and connected via its other end to the microchannel.

The end of the microchannel opposite from said feeder well may be closed, or else it may open out into another feeder well.

Under such circumstances, a middle portion of the microchannel has a section greater than that of the end portions of the microchannel that are connected to the feeder wells, thereby forming a liquid mixer zone.

According to another characteristic of the invention, a plurality of microchannels can be connected via one end to a common feeder well.

In a preferred embodiment of the invention, the microchannel is formed in a bottom face of the component that is applied against a suitable support forming the bottom of the microchannel, and the feeder well opens out into a top face of the component.

The support may be made of glass, of a non-degassable plastics material, or of any suitable material, and it may optionally constitute a unitary assembly together with the component.

The invention is applicable in numerous fields: fluidic damping, analyzing biological or chemical samples, heterogeneous catalytic reactions, DNA hybridation, aggregating particles, etc.

### BRIEF DESCRIPTION OF THE DRAWINGS

The invention can be better understood and other characteristics, details, and advantages thereof appear more clearly on reading the following description made by way of example with reference to the accompanying drawings, in which:

FIG. 1 is a diagram of a component of the invention vacuum packed in a hermetic package;

FIG. 2 is a diagrammatic section view of the component extracted from its package and placed on a suitable support;

FIGS. 3, 4, and 5 are views corresponding to FIG. 2 and showing three steps in filling a microchannel of the component with a liquid;

FIG. 6 is a diagrammatic plan view of a variant embodiment of the component;

FIG. 7 is a diagrammatic plan view of another variant embodiment of the component; and

FIG. 8 is a flow chart showing the principal steps of the method of the invention.

### MORE DETAILED DESCRIPTION

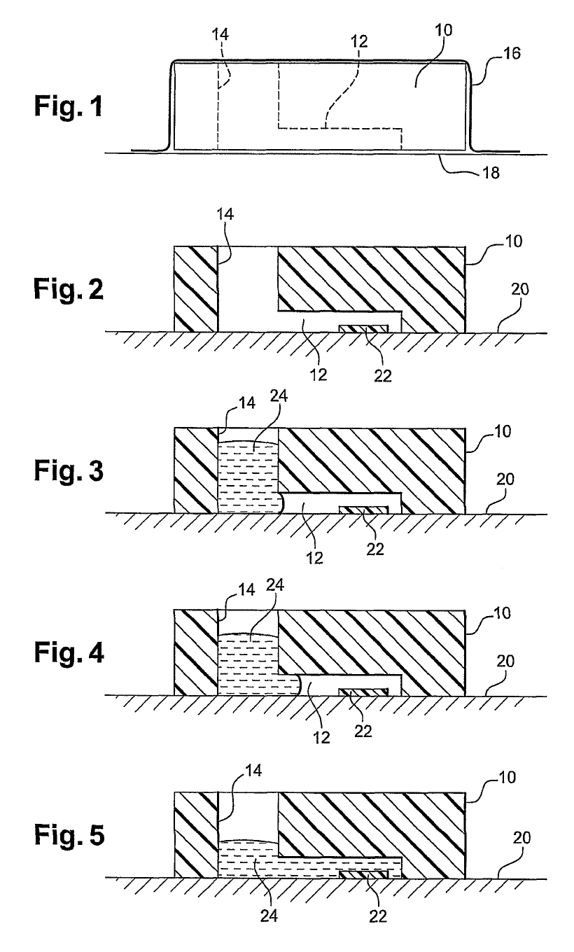

The component 10 shown diagrammatically in FIGS. 1 to 5 is a component of a fluidic microsystem made at least in part out of an elastomer such as polydimethylsiloxane (PDMS) and present in the form of a small block or slab having one face that includes a microchannel 12 connected via one of its ends to a feed well 14 that opens into an opposite face of the component 10, the other end of the microchannel being closed (not opening out).

According to the invention, the elastomer component 10 is degassed under a vacuum and packaged under a vacuum in a hermetic package 16 made of an appropriate gastight material.

By way of example, the package 16 forms a cell in which the component 10 is placed and that is closed in sealed manner by a capsule 18.

The degassing to which the component 10 is subjected prior to packaging is performed under a partial vacuum at a pressure of 100 mbars to 200 mbars (10⁴ Pa to 2×10⁴ Pa), for example, for a duration of one to two hours, approximately.

In order to be used, the component 10 is extracted from its package 16 and placed on an appropriate support 20, such as a plate of glass or a suitable plastics material, for example, with the component 10 being placed on said plate 20 via its face in which the microchannel 12 is formed.

The microchannel contains a reagent 22 that is secured at a predetermined point of the support 20, e.g. by grafting.

When the component 10 is made of PDMS or the like, it adheres naturally on the support 20 made of glass or plastics material.

Thereafter, a liquid 24 is inserted into the well 14, as shown in FIG. 3, so as to fill at least a portion of said well with the liquid 24 which then forms a plug separating the microchannel 12 from the surrounding atmosphere.

In this example, the material of the component 10 is naturally hydrophobic and this property of the material and the gas contained in the microchannel 12 oppose filling of the microchannel 12 with the liquid and oppose the liquid coming into contact with the reagent 22.

Nevertheless, the component 10 after being degassed under a vacuum, absorbs any gas with which it comes into contact, and in particular the gas (i.e. usually air) that fills the microchannel 12. This absorption leads to a drop in the pressure inside the microchannel 12 and thus to the liquid contained in the well 14 being sucked in. The gas absorption capacities of the degassed material of the component 10 are such that all of the gas contained in the microchannel 12 can be absorbed by the component 10 and replaced progressively by the liquid 24 contained in the well 14, as shown diagrammatically in FIGS. 4 and 5.

If the liquid 24 itself contains any bubbles of air or gas, these bubbles will be absorbed by the material of the component 10 while the microchannel 12 is filling with the liquid 24.

Once the microchannel 12 is completely filled, as shown in FIG. 5, it is possible to proceed with the intended operations for performing a given reaction between the liquid 24 and the reagent 22, these operations comprising, for example: cycles of heating, of maintaining temperature, etc. . . . for a duration of greater or shorter length.

During this treatment, the material of the component 10 that has reabsorbed relatively little gas since being unpackaged is not in a position over a duration of several hours to release any bubbles of air or gas into the liquid 24 contained in the microchannel 12, thus making it possible to perform the intended reactions without difficulty.

Typically, the component 10 that has been degassed and vacuum packaged as mentioned above should be used within 15 min to 20 min after the package 16 has been opened, with gas reabsorption by the material of the component 10 being sufficient to fill the microchannel(s) 12 with the appropriate liquid(s), after which the component 10 can be used during 5 hours (h) to 6 h approximately without releasing bubbles of gas into the microchannel(s) 12 while it is in use.

The configuration of the component and of its microchannel(s) and feeder well can be arbitrary.

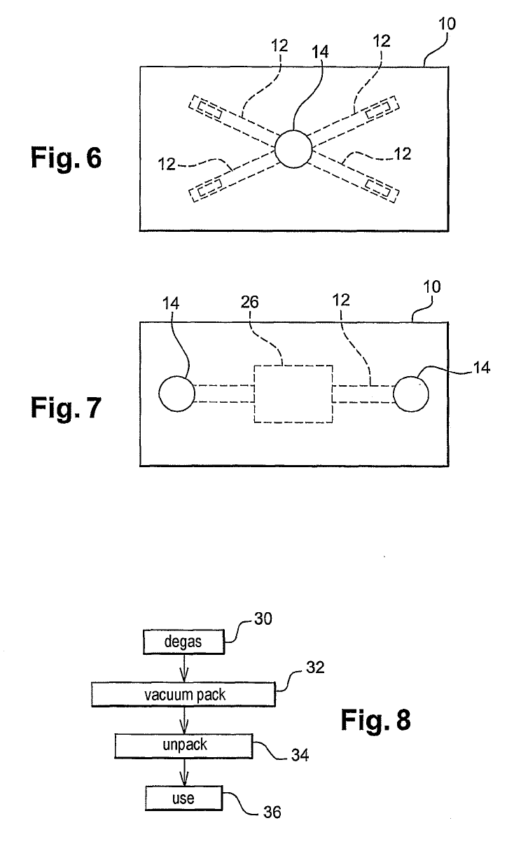

For example, as shown diagrammatically in FIG. 6, a single feeder well 14 can be connected to the ends of a plurality of microchannels 12 extending in a star configuration about the well 14.

As shown diagrammatically in FIG. 7, a single microchannel 12 may be connected via its ends to two feeder wells 14 and may have a middle zone 26 of large size, forming a zone in which the liquids inserted into the well 14 mix.

Numerous other variant configurations are naturally possible.

Typically and conventionally, the dimensions of the microchannels 12 are a few tens to a few hundreds of micrometers (μm) in height and in width.

Nevertheless, where useful, the invention makes it possible to use microchannels having dimensions in height and in weight that are smaller than those mentioned above and that would be very difficult to fill with liquid by the means known in the prior art.

The filling method of the invention makes it possible under all circumstances to fill the microchannels 12 completely, even if they are of very small dimensions and even if the material of the component 10 is hydrophobic.

As shown diagrammatically in FIG. 8, the method of the invention consists essentially in prior degassing 30 of the component 10 by exposing it to a partial vacuum for a sufficient duration, this degassing being followed by vacuum packaging 32 in a hermetic package, the component 10 as packaged in this way being capable of being stored for a certain length of time.

In order to be used, the component 10 is unpackaged (step 34) and must be used (36) within the following 15 min to 20 min after the hermetic package has been opened.

In a variant, it is naturally possible to degas the component 10 in the manner described, and then to use it within 15 min to 20 min following the end of degassing, without the component being packaged in the meanwhile in a hermetic package.

In another variant, it is also possible to place or to fasten the component 10 on the support 20 including the reagent(s) 22, so as to degas the assembly comprising the component 10 and the support 20 in the above-described manner, to enclose the assembly in a vacuum within a leaktight package, and to store it prior to using it.

What is claimed is:

1. A method of filling a microchannel in a component of a fluidic microsystem, the component being made at least in part out of a plastics material or out of an elastomer suitable for absorbing the gases with which it is in contact, the method comprising subjecting the component to degassing under a vacuum, then placing the component in a surrounding or ambient atmosphere, inserting a liquid in the microchannel of the component, and filling the microchannel with the liquid by allowing the suction that results from the component absorbing the gas contained in the microchannel to act on the liquid.

2. A method of filling according to claim 1, comprising enclosing the degassed component under a vacuum in a hermetic package and, subsequently, opening the package to use the component, said use comprising inserting liquid into the microchannel of the component, the time interval between opening the package containing the component and introducing the liquid into the microchannel of the component being shorter than a predetermined value.

3. A method of filling according to claim 2, wherein the time interval lies in the range 15 min to 20 min approximately when the component is made of an elastomer of the PDMS type.

4. A method of filling according to claim 1, comprising inserting the liquid into a feeder well formed at one end of the microchannel such that the liquid inserted into the well forms an obstacle isolating the microchannel from the surrounding atmosphere.

5. A method of filling according to claim 1, wherein the component is degassed under a partial vacuum for a predetermined minimum duration.

6. A method of filling according to claim 5, wherein the duration of the degassing is about 1 to 2 hours when the degassing is performed at a pressure of about 100 mbars to 200 mbars.

7. A method of filling according to claim 1, wherein the component is placed or fastened on a support while it is being degassed, and then packaged under a vacuum.

8. A component of a fluidic microsystem, made at least in part out of a plastics material or an elastomer capable of absorbing gas and including at least one microchannel that is to be filled with a liquid, the component being previously degassed under a vacuum and is packaged under a vacuum in a hermetic package.

9. A component according to claim 8, including at least one feeder well open at one of its ends and connected to the microchannel at its other end.

10. A component according to claim 9, wherein the end of the microchannel remote from the feeder well is closed.

11. A component according to claim 9, wherein the end of the microchannel remote from the feeder well opens out into another feeder well.

12. A component according to claim 11, wherein a middle portion of the microchannel has sectional dimensions greater than those of the end portions of the microchannel connected to the feeder well and forms a liquid mixer zone.

13. A component according to claim 9, wherein a plurality of microchannels are connected to a common feeder well.

14. A component according to claim 8, wherein the microchannel is formed in a bottom face of the component that is applied against a suitable support forming the bottom of the microchannel, and wherein the feeder well opens out into a top face of the component.
